(19) United States
(12) Patent Application Publication
(10) Pub. No.: US 2025/0092268 A1
(43) Pub. Date: Mar. 20, 2025

(54) AUTOMOTIVE COATINGS CONTAINING CLOSED-CELL METAL OXIDE PARTICLES

(71) Applicant: BASF COATINGS GMBH, Munster (DE)

(72) Inventors: Zenon Paul CZORNIJ, Brighton, MI (US); Rupa Hiremath DARJI, Tarrytown, NY (US); Michael David BURKE, Tarrytown, NY (US); Liangliang QU, Tarrytown, NY (US); Keith TASK, Beachwood, OH (US)

(21) Appl. No.: 18/729,699

(22) PCT Filed: Jan. 13, 2023
(86) PCT No.: PCT/US2023/010806

§ 371 Date: Jul. 17, 2024

Related U.S. Application Data
(60) Provisional application No. 63/300,420, filed on Jan. 18, 2022.

(51) Int. Cl. C09D 5/02; C08K 3/013; C08K 3/04; C09D 5/33; C09D 175/04

(52) U.S. Cl. CPC C09D 5/028; C09D 5/004; C09D 175/04; C08K 3/013; C08K 3/04; C08K 2201/003

(57) ABSTRACT

Disclosed in certain embodiments is a coating composition comprising (i) a solvent, (ii) a resinous binder, and (iii) a structural colorant comprising closed-cell metal oxide particles, and corresponding coatings, coated automotive parts and methods thereof.

### CROSS-REFERENCE TO RELATED APPLICATION(S)

This application claims the benefit of priority of U.S. Provisional Patent Application No. 63/300,420, filed on Jan. 18, 2022, the disclosure of which is hereby incorporated by reference herein in its entirety.

### TECHNICAL FIELD

Disclosed are automotive coatings that include a structural colorant in the form of closed-cell metal oxide particles as well as coating compositions and methods thereof.

### BACKGROUND

Traditional pigments and dyes exhibit color via light absorption and reflection, relying on chemical structure. Structural colorants exhibit color via light interference effects, relying on physical structure as opposed to chemical structure. Structural colorants are found in nature, for instance in bird feathers, butterfly wings and certain gemstones. Structural colorants are materials containing microscopically structured surfaces small enough to interfere with visible light and produce color.

Structural colorants can be manufactured to provide color in various goods such as paints and automotive coatings. For manufactured structural colorants, it is desired that the material exhibits high chromatic values, special photonic effects, dimensions allowing their use in particular applications, and chemical and thermal robustness. The robustness of the material is important in order to allow their in-process stability in paint systems and under various natural weathering conditions.

There exists a continued need in the art for automotive coatings that include structural colorants that provides a diverse range of robust colors.

### SUMMARY OF THE INVENTION

The following summary presents a simplified summary of various aspects of the present disclosure in order to provide a basic understanding of such aspects. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

It is an object of certain embodiments of the present invention to provide an automotive coating composition that includes a structural colorant.

It is another object of certain embodiments of the present invention to provide a method of preparing an automotive coating composition that includes a structural colorant.

It is a further object of certain embodiments of the present invention to provide an automotive coating that includes a structural colorant.

It is a further object of certain embodiments of the present invention to provide a manufactured automotive article that has a substrate and a coating that includes a structural colorant.

One or more of the above objects and others can be achieved by virtue of the present invention which in certain embodiments is directed to a coating composition comprising (i) a solvent, (ii) a resinous binder and (iii) a structural colorant comprising closed-cell metal oxide particles.

In at least one embodiment, each closed-cell metal oxide particle comprises a metal oxide matrix defining an array of closed-cells, each closed-cell encapsulating a media-inaccessible void volume. In at least one embodiment, the outer surface of the closed-cell metal oxide particle is defined by the array of closed-cells.

In at least one embodiment, the metal oxide matrix comprises a metal oxide selected from silica, titania, alumina, zirconia, ceria, iron oxides, zinc oxide, indium oxide, tin oxide, chromium oxide, and combinations thereof.

In at least one embodiment, the metal oxide matrix comprises a metal oxide selected from silica, titania, and a combination thereof.

In at least one embodiment, the array of the closed-cells is an ordered array.

In at least one embodiment, the array of the closed-cells is a disordered array.

In at least one embodiment, the closed-cell metal oxide particles have an average diameter of from about 1 μm to about 75 μm.

In at least one embodiment, the closed-cell metal oxide particles have an average void volume diameter of from about 50 nm to about 800 nm.

In at least one embodiment, the closed-cell metal oxide particles have an average porosity of from about 0.45 to about 0.65.

In at least one embodiment, the structural colorant exhibits angle-dependent color or angle-independent color.

In at least one embodiment, the ratio of structural colorant to resinous binder is about 1:100 to about 50:100; about 5:100 to about 25:100; about 10:100 to about 20:100 or about 15:100.

In at least one embodiment, the structural colorant is de-agglomerated.

In at least one embodiment, the structural colorant is de-agglomerated by sonification.

In at least one embodiment, at least a portion of the external surface of the structural colorant comprises silane functional groups.

In at least one embodiment, the structural colorant comprises transition metal ions.

In at least one embodiment, the structural colorant comprises carbon black.

In at least one embodiment, the coating composition is formulated as an automotive coating.

In at least one embodiment, the coating composition provides a coating that exhibits an L* value from 15 degree angle to 110 degree angle from specular reflection that does not change by more than about 50%, by more than about 35% or by more than about 25%.

In at least one embodiment, the coating composition provides a coating that exhibits an L* value that increases from 15 degree angle to 110 degree angle from specular reflection.

In at least one embodiment, the coating composition provides a coating that exhibits an L* value from 15 degree angle to 110 degree angle from specular reflection that changes more than about 3 units, more than about 5 units or more than about 10 units.

In at least one embodiment, the coating composition provides a coating that exhibits an L* value from 15 degree angle to 110 degree angle from specular reflection that changes less than about 25 units, less than about 15 units or less than about 10 units.

In at least one embodiment, the coating composition provides a coating that exhibits a C* value from 15 degree angle to 110 degree angle from specular reflection that does not change by more than about 50%, by more than about 35% or by more than about 25%.

In at least one embodiment, the coating composition provides a coating that exhibits a C* value that changes from 15 degree angle to 110 degree angle from specular reflection.

In at least one embodiment, the coating composition provides a coating that exhibits a C* value from 15 degree angle to 110 degree angle from specular reflection that changes more than about 3 units, more than about 5 units or more than about 10 units.

In at least one embodiment, the coating composition provides a coating that exhibits a C* value from 15 degree angle to 110 degree angle from specular reflection that changes less than about 25 units, less than about 15 units or less than about 10 units.

In at least one embodiment, the coating composition provides a coating that exhibits an h value from 15 degree angle to 110 degree angle from specular reflection that does not change by more than about 75%, by more than about 50%, by more than about 25% or by more than about 10%.

In at least one embodiment, the coating composition provides a coating that exhibits an h value that changes from 15 degree angle to 110 degree angle from specular reflection.

In at least one embodiment, the coating composition provides a coating that exhibits an h value from 15 degree angle to 110 degree angle from specular reflection that changes more than about 25 units, more than about 50 units or more than about 100 units.

In at least one embodiment, the coating composition provides a coating that exhibits an h value from 15 degree angle to 110 degree angle from specular reflection that changes less than about 200 units, less than about 150 units or less than about 100 units.

In at least one embodiment, the coating composition provides a coating that exhibits an a* value from 15 degree angle to 110 degree angle from specular reflection that does not change by more than about 10 units, by more than about 5 units or more than about 2 units.

In at least one embodiment, the coating composition provides a coating that exhibits a b* value from 15 degree angle to 110 degree angle from specular reflection that does not change by more than about 25 units, by more than about 15 units or more than about 10 units.

Further embodiments are directed to automotive parts comprising the coatings disclosed herein and methods thereof.

Further embodiments are directed to coatings derived from any of the aforementioned coating compositions.

In at least one embodiment, a coating comprises a colorant layer comprising (i) a resinous binder and (ii) a structural colorant comprising closed-cell metal oxide particles.

In at least one embodiment, the coating further comprises a ground coat, the colorant layer being layered over the ground coat.

In at least one embodiment, the ground coat exhibits an angle-independent L* value of less than 70.

In at least one embodiment, the coating further comprises a clear coat layer, the clear coat being layered over the colorant layer.

In at least one embodiment, the coating further comprises one or more additional layers (i) between the ground layer and the colorant layer, (ii) between the colorant layer and the clear coat layer, (iii) over the clear coat layer, (iv) under the ground layer, or a combination thereof.

In at least one embodiment, the structural colorant exhibits angle-dependent color or angle-independent color.

In at least one embodiment, the coating exhibits an L* value from 15 degree angle to 110 degree angle from specular reflection that does not change by more than about 50%, by more than about 35% or by more than about 25%.

In at least one embodiment, the coating exhibits a C* value from 15 degree angle to 110 degree angle from specular reflection that changes by more than about 50%, by more than about 35% or by more than about 25%.

In at least one embodiment, the coating exhibits an h value from 15 degree angle to 110 degree angle from specular reflection that changes by more than about 75%, by more than about 50%, or by more than about 25%.

In at least one embodiment, the coating exhibits an a* value from 15 degree angle to 110 degree angle from specular reflection that does not change by more than about 10 units, by more than about 5 units or more than about 2 units.

In at least one embodiment, the coating exhibits a b* value from 15 degree angle to 110 degree angle from specular reflection that does not change by more than about 25 units, by more than about 15 units or more than about 10 units.

Further embodiments are directed to an article of manufacture comprising a substrate and a coating of any of the preceding embodiments. In at least one embodiment, the coating the substrate is an automotive part. In at least one embodiment, the coating the automotive part is an external panel or an interior part.

Further embodiments are directed to a method of preparing a coating composition, the method comprising mixing a solvent, a resinous binder and a structural colorant comprising photonic spheres to obtain the coating composition of any of the preceding embodiments.

In at least one embodiment, the method further comprises mixing the solvent and the structural colorant and thereafter adding the resinous binder.

In at least one embodiment, the method further comprises de-agglomerating the structural colorant. In at least one embodiment, the de-agglomeration is prior to adding the resinous binder. In at least one embodiment, the de-agglomeration is by sonification.

Further embodiments are directed to a method of coating a substrate, the method comprising layering a coating composition of any of the preceding embodiments onto a substrate.

In at least one embodiment, the method further comprises selecting physical characteristics of the structural colorant to achieve a pre-determined color standard.

In at least one embodiment, the color standard has been previously attained by the structural colorant.

In at least one embodiment, the color standard is based on a color achieved by a chemical colorant.

In at least one embodiment, the physical characteristics comprise one or more of closed-cell metal oxide particle diameter or a diameter of closed-cells of the closed-cell metal oxide particles.

In at least one embodiment, the substrate is an automotive part. In at least one embodiment, the automotive part is an external panel or an interior part.

In at least one embodiment, the color standard corresponds to a wavelength of 380-450 nm, 450-485 nm, 485-500 nm, 500-565 nm, 565-590 nm, 590-625 nm or 625-704 nm.

In at least one embodiment, the color of the layered substrate is the same or substantially the same as the color standard based on spectrophotometry measurement.

### BRIEF DESCRIPTION OF DRAWINGS

The disclosure described herein is illustrated by way of example and not by way of limitation in the accompanying figures.

FIG. 1A illustrates a metal oxide particle with a closed-cell morphology according to certain embodiments of the present disclosure.

FIG. 1B illustrates a comparative metal oxide particle having a porous exterior surface.

FIG. 2 illustrates a process of preparing metal oxide particles having closed-cell morphologies according to certain embodiments of the present disclosure.

FIG. 3 shows a schematic of an exemplary spray drying system used in accordance with various embodiments of the present disclosure.

### DETAILED DESCRIPTION

The present invention relates to automotive coating compositions containing structural colorants. More specifically, certain embodiments relate to coating compositions comprising a solvent, a resinous binder, and a colorant or a combination of colorants to produce a characteristic color. The colorants may be structural colorants, classical pigments, effect pigments, or any combination thereof. The structural colorants may be produced by different means and include different types of materials such as, but not limited to, photonic crystals, opals, or inverse opals derived from colloidal structures.

Unlike classical pigments, which rely on chemical properties to absorb and reflect light to produce their characteristic color, structural colorants rely on physical properties to generate color by light interference. The light interference takes place in the nanostructures present in the colorant particles. The particles may arise from photonic crystals, photonic structures, opals, inverse opals, etc.

The ability to generate innovative and aesthetically pleasing colors for the automotive market depends largely on the colorants used in the formulation. Oftentimes limitations exist for so-called traditional pigments or effect pigments because they may not have sufficient performance characteristics to meet the engineering requirements of an automotive coating over the service life of the car. For example, pigments may tend to fade or darken after months or years of being exposed to sunlight. Structural colorants offer the potential to produce innovative colors that may be angle-dependent or angle-independent, for example, yet be more stable for lightfastness. This stability against photodegradation gives coatings formulators greater degrees of freedom to make useful combinations and formulate the colorants at levels heretofore not feasible with traditional pigments.

Certain embodiments relate to automotive coating colors formulated with closed-cell metal oxide particles as structural colorants. These photonic particles are composed of metal oxides and can generate colors that exhibit angle-dependent iridescence or angle-independent hues. The photonic particles may be synthesized to obtain a range of different particle sizes and internal pore sizes, as well as different matrix and template materials with which to seal the surface pores from infiltration of the paint medium. These structures can be used to create a palette of visible colors.

The overall coloristic effects may be enhanced by using combinations of coatings layers wherein structural colorants are used among these coatings layers, resulting in saturated colors of varying degrees. An expanded automotive color space may be possible, since structural colorants offer benefits such as improved weatherfastness when compared to classical absorption pigments. Such pigmentation levels achievable by the structural colorants described herein may not be feasible with classical absorption pigments. Moreover, the embodiments described herein advantageously provide for expanded color design potential without sacrificing durability (lightfastness).

The terms “structural colorant” refers to particles that form colors due to their structural morphology rather than molecular properties. In particular, the particle exhibit color via light interference effects, relying on microscopically structured surfaces small enough to interfere with visible light and produce color as opposed to their chemical structure. The colors that result from this mechanism can be selected by alterations to the structure of a chosen material, allowing one material to exhibit various colors throughout the visible spectrum with no change to the chemical nature of the material itself. The creation of these particles through a colloidal dispersion procedure and their optimization for color is discussed herein.

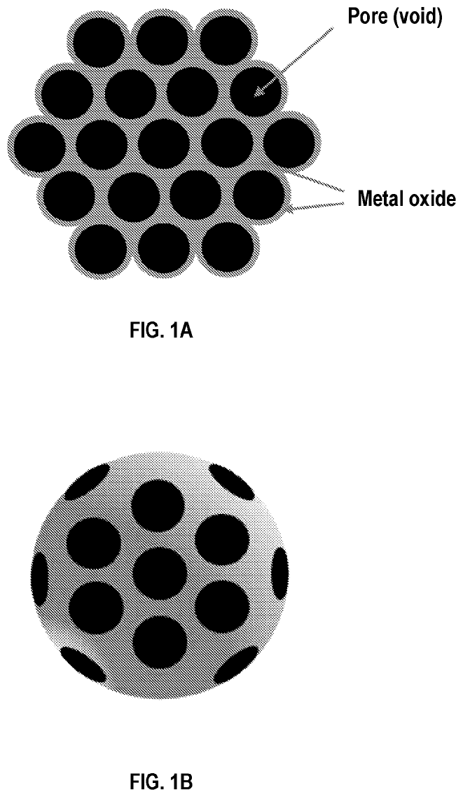

Certain embodiments further relate to coating compositions that incorporate closed-cell metal oxide particles as structural colorants, which comprise a metal oxide matrix having an array of pores (referred to as “void volumes” or “voids,” which may comprise air) formed therein of substantially uniform sizes, as illustrated by a cross-sectional view in FIG. 1A. As illustrated, the closed-cell metal oxide particle is formed from a metal oxide matrix which defines an array of “closed-cells” that encapsulate media-inaccessible void volumes. An outer surface of the closed-cell metal oxide particle (depicted as an overcoated surface formed by the metal oxide) is defined by the array of closed-cells such that there are substantially no open pores of similar size to the closed-cells at the surface.

In contrast to the present embodiments, the porous metal oxide particle shown in FIG. 1B has pores on its exterior surface and connected pores inside. When formulated into a medium, the medium infiltrates into these pores, resulting in a loss of color effects in the downstream formulation due to the refractive index match between medium and matrix material. This greatly limits the applications of porous particles in a variety of formulations. The closed-cell metal oxide particles of the present embodiments are impermeable to polymers, large molecules, or other viscous materials frequently used in coating formulations, and thus can prevent penetration into the pores and retaining air in the pores. Thus, the close-cell metal oxide particles advantageously maintain a constant net refractive index between the matrix and voids regardless of the surrounding media in the application.

Closed-cell metal oxide particles have physical parameters that can be tuned to enhance performance properties of their corresponding coating compositions. By way of example, and not to be considered limiting, physical parameters that can be adjusted include the particle size diameters, particle size distributions, particle shapes, void volume (pore) diameter within the particles, porosity, packing density, surface texture, and the degree of order with regard to the spatial arrangement of the closed-cells of the particles. Chemical parameters that can be adjusted include the chemical make-up of the particles, including the composition of the matrix and surface functionalizations. When used in coating compositions, the particles can be added in a sufficient amount to enhance reflective properties and optionally replace existing components such as pigments and/or fillers in the coating compositions. The terms “tuned,” “adjusted,” and “configured” can be used interchangeably and refer to an adjustment to a physical and/or chemical parameter of the particles to change their reflectance properties. The closed-cell metal oxide particles described herein can exhibit high stability and thus can be formulated into colored coating compositions as a replacement for less stable and/or less environmentally friendly pigments or dyes.

Depending upon the physical parameters of the closed-cell metal oxide particles, they can have a broad range of uses in coating compositions. The closed-cell metal oxide particles can be synthesized as to adjust (1) the microsphere size diameter, (2) the void volume diameters within the closed-cell metal oxide particles (3) the degree of order with regards to the spatial arrangement of the voids in the closed-cell metal oxide particles, and (4) the average distance between the void volumes.

Non-limiting examples of exemplary components used in coating compositions are now described.

### Closed-Cell Metal Oxide Particles

Certain embodiments utilize closed-cell metal oxide particles in the various coating compositions described herein. Closed-cell metal oxide particles may be produced, for example, as described in International Application No. PCT/IB2021/000499, filed on Jul. 21, 2021, the disclosure of which is hereby incorporated by reference herein in its entirety.

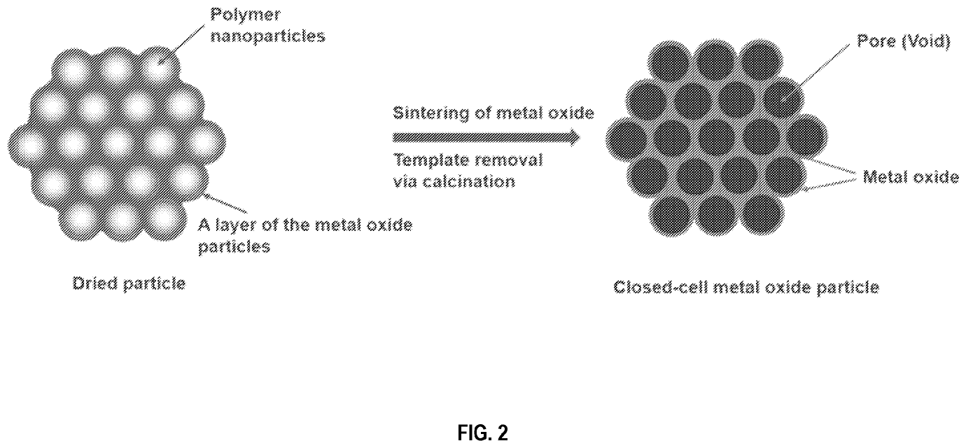

FIG. 2 illustrates an exemplary process for forming the closed-cell metal oxide particles. In certain embodiments, the closed-cell metal oxide particles are produced by drying droplets of a formulation comprising a matrix of metal oxide particles on the order of 1 to 120 nm in diameter, and polymer particles on the order of 50 to 500 nm which will serve as the template. In certain embodiments, the two particle species are oppositely charged (e.g., positively charged polymer particles and negatively charged metal oxide particles) to facilitate formation of a coating of the metal oxide particles on the polymer particles. In certain embodiments, a spray drying or microfluidics process is used to generate the droplets (e.g., aqueous droplets), and the droplets are dried to remove their solvent. In certain embodiments that utilize a spray drying process, the generation of droplets and drying is performed in rapid succession. During the drying process, the polymer particles and the metal oxide particles self-assemble to form a microsphere containing polymer particles embedded in a metal oxide matrix. By sintering the matrix nanoparticles, for example, in a muffle furnace, the matrix nanoparticles densify and form a stable matrix around the polymer particles. During this process, the polymer particles are removed via calcination, resulting in a final closed-cell particle having an array of closed-cells formed therein.

The resulting closed-cell metal oxide particles may be spherical and μm-scaled, for example, having average diameters from about 0.5 μm to about 100 μm. In certain embodiments, the closed-cell metal oxide particles have an average diameter from about 0.5 μm, about 0.6 μm, about 0.7 μm, about 0.8 μm, about 0.9 μm, about 1.0 μm, about 5.0 μm, about 10 μm, about 20 μm, about 30 μm, about 40 μm, about 50 μm, about 60 μm, about 70 μm, about 80 μm, about 90 μm, about 100 μm, or within any range defined by any of these average diameters (e.g., about 1.0 μm to about 20 μm, about 5.0 μm to about 50 μm, etc.). The metal oxide employed may also be in particle form, and may be nano-scaled. The metal oxide matrix particles may have an average diameter, for example, of about 1 nm to about 120 nm. The polymer template particles may have an average diameter, for example, of about 50 nm to about 500 nm. One or more of the polymer particles or the metal oxide particles may be polydisperse or monodisperse. In certain embodiments, the metal oxide may be provided as metal oxide particles or may be formed from a metal oxide precursor, for example, via a sol-gel technique.

Certain embodiments of the closed-cell metal oxide particles exhibit color in the visible spectrum at a wavelength range selected from the group consisting of 380 nm to 450 nm, 451 nm to 495 nm, 496 nm to 570 nm, 571 nm to 590 nm, 591 nm to 620 nm, 621 nm to 750 nm, 751 nm to 800 nm, and any range defined therebetween (e.g., 496 nm to 620 nm, 450 nm to 750 nm, etc.). In certain embodiments, the particles exhibit a wavelength range in the ultraviolet spectrum selected from the group consisting of 100 nm to 400 nm, 100 nm to 200 nm, 200 nm to 300 nm, and 300 nm to 400 nm.

The average particle diameter (also referred to herein as average particle size) of the particles can be determined by scanning electron microscopy (SEM) or transmission electron microscopy (TEM). Particle size may also be measured by laser light scattering techniques with dispersions or dry powders. Average particle size is synonymous with D50, meaning half of the population resides above this point, and half below.

In certain embodiments, the closed-cell metal oxide particles can have, for example, one or more of an average diameter of from about 0.5 μm to about 100 μm, an average porosity of greater than about 0.1, greater than about 0.2, greater than about 0.3, greater than about 0.4, greater than about 0.5, greater than about 0.6, greater than about 0.7, greater than about 0.8, or about 0.10 to about 0.80, and an average void volume (pore) diameter of from about 50 nm to about 500 nm. In other embodiments, the particles can have, for example, one or more of an average diameter of from about 1 μm to about 75 μm, an average porosity of from about 0.10 to about 0.40, and an average void volume (pore) diameter of from about 50 nm to about 800 nm.

In certain embodiments, the closed-cell metal oxide particles have an average diameter, for example, of from about 1 μm to about 75 μm, from about 2 μm to about 70 μm, from about 3 μm to about 65 μm, from about 4 μm to about 60 μm, from about 5 μm to about 55 μm, or from about 5 μm to about 50 μm; for example, from any of about 5 μm, about 6 μm, about 7 μm, about 8 μm, about 9 μm, about 10 μm, about 11 μm, about 12 μm, about 13 μm, about 14 μm, or about 15 μm to any of about 16 μm, about 17 μm, about 18 μm, about 19 μm, about 20 μm, about 21 μm, about 22 μm, about 23 μm, about 24 μm, or about 25 μm. Other embodiments can have an average diameter of from any of about 4.5 μm, about 4.8 μm, about 5.1 μm, about 5.4 μm, about 5.7 μm, about 6.0 μm, about 6.3 μm, about 6.6 μm, about 6.9 μm, about 7.2 μm, or about 7.5 μm to any of about 7.8 μm about 8.1 μm, about 8.4 μm, about 8.7 μm, about 9.0 μm, about 9.3 μm, about 9.6 μm, or about 9.9 μm.

In certain embodiments, the closed-cell metal oxide particles have an average porosity, for example, of from any of about 0.10, about 0.12, about 0.14, about 0.16, about 0.18, about 0.20, about 0.22, about 0.24, about 0.26, about 0.28, about 0.30, about 0.32, about 0.34, about 0.36, about 0.38, about 0.40, about 0.42, about 0.44, about 0.46, about 0.48 about 0.50, about 0.52, about 0.54, about 0.56, about 0.58, or about 0.60 to any of about 0.62, about 0.64, about 0.66, about 0.68, about 0.70, about 0.72, about 0.74, about 0.76, about 0.78, about 0.80, or about 0.90. Other embodiments can have an average porosity of from any of about 0.45, about 0.47, about 0.49, about 0.51, about 0.53, about 0.55, or about 0.57 to any of about 0.59, about 0.61, about 0.63, or about 0.65. For example, the closed-cell metal oxide particles can have an average porosity of from 0.10 to 0.90, from 0.10 to 0.80, from 0.15 to 0.80, from 0.20 to 0.70, from 0.20 to 0.60, from 0.45 to 0.70, from 0.40 to 0.65, from 0.45 to 0.65, or from 0.45 to 0.55.

The term “porous,” as used herein, refers to one or more interconnected or non-interconnected pores, voids, spaces, or interstices that allow air or liquid to pass through. The term “porosity” as used herein refers to a measure of the empty spaces (or voids or pores) in the particles and is a ratio of the volume of voids to total volume of the mass of the closed-cell metal oxide particles between 0 and 1, or as a percentage between 0 and 100%. Average porosity of the closed-cell metal oxide particles means the total pore volume, as a fraction of the volume of the entire closed-cell metal oxide particle. Mercury porosimetry analysis can be used to characterize the porosity of the particles. Mercury porosimetry applies controlled pressure to a sample immersed in mercury. External pressure is applied for the mercury to penetrate into the voids/pores of the material. The amount of pressure required to intrude into the voids/pores is inversely proportional to the size of the voids/pores. A mercury porosimeter generates volume and pore size distributions from the pressure versus intrusion data generated by the instrument using the Washburn equation. Porosity, as reported herein for closed-cell metal oxide particles, is calculated as a ratio of unoccupied space and total particle volume. For example, porous silica particles containing voids/pores with an average size of 165 nm have an average porosity of 0.8. The closed-cell metal oxide particles can contain uniform or non-uniform pore diameters.

In certain embodiments, the closed-cell metal oxide particles have an average void volume (pore) diameter of about 3 nm, about 4 nm, about 5 nm, about 10 nm, about 20 nm, or about 25 nm to about 30 nm, about 35 nm, about 40 nm, about 45 nm, or about 50 nm. In other embodiments, the metal oxide particles have an average void volume (pore) diameter, for example, of from any of about 10 nm, about 20 nm, about 30 nm, about 40 nm, about 50 nm, about 60 nm, about 70 nm, about 80 nm, about 100 nm, about 120 nm, about 140 nm, about 160 nm, about 180 nm, about 200 nm, about 220 nm, about 240 nm, about 260 nm, about 280 nm, about 300 nm, about 320 nm, about 340 nm, about 360 nm, about 380 nm, about 400 nm, about 420 nm, or about 440 nm to any of about 460 nm, about 480 nm, about 500 nm, about 520 nm, about 540 nm, about 560 nm, about 580 nm, about 600 nm, about 620 nm, about 640 nm, about 660 nm, about 680 nm, about 700 nm, about 720 nm, about 740 nm, about 760 nm, about 780 nm, or about 800 nm. Other embodiments can have an average void volume (pore) diameter of from any of about 220 nm, about 225 nm, about 230 nm, about 235 nm, about 240 nm, about 245 nm, or about 250 nm to any of about 255 nm, about 260 nm, about 265 nm, about 270 nm, about 275 nm, about 280 nm, about 285 nm, about 290 nm, about 295 nm, or about 300 nm. Average pore diameter can be determined by electron microscopy.

The term “metal oxide” refers to oxygen containing species of various metals, such as silicon, titanium, aluminum, zirconium, cerium, iron, zinc, indium, tin, chromium, antimony, bismuth, cobalt, gallium, lanthanum, molybdenum, neodymium, nickel, niobium, vanadium, or combinations thereof. In certain embodiments, the metal oxide material of the closed-cell metal oxide particles is selected from silica, titania, alumina, zirconia, ceria, iron oxides, zinc oxide, indium oxide, tin oxide, chromium oxide, or combinations thereof. In certain embodiments, the metal oxide comprises SiO₂, TiO₂, Ti₂O₃, Al₂O₃, or Fe₂O₃.

In certain embodiments, the polymer of the polymer particles is selected from poly(meth)acrylic acid, poly(meth)acrylates, polystyrenes, polyacrylamides, polyvinyl alcohol, polyvinyl acetate, polyesters, polyurethanes, polyethylene, polypropylene, polylactic acid, polyacrylonitrile, polyvinyl ethers, derivatives thereof, salts thereof, copolymers thereof, or combinations thereof. For example, the polymer is selected from the group consisting of polymethyl methacrylate, polyethyl methacrylate, poly(n-butyl methacrylate), polystyrene, poly(chloro-styrene), poly(alpha-methylstyrene), poly(N-methylolacrylamide), styrene/methyl methacrylate copolymer, polyalkylated acrylate, polyhydroxyl acrylate, polyamino acrylate, polycyanoacrylate, polyfluorinated acrylate, poly(N-methylolacrylamide), polyacrylic acid, polymethacrylic acid, methyl methacrylate/ethyl acrylate/acrylic acid copolymer, styrene/methyl methacrylate/acrylic acid copolymer, polyvinyl acetate, polyvinylpyrrolidone, polyvinylcaprolactone, polyvinylcaprolactam, a co-polymer of methyl methacrylate and [2-(methacryloyloxy)ethyl]trimethylammonium chloride, derivatives thereof, salts thereof, or combinations thereof.

In certain embodiments, a weight to weight ratio of the metal oxide particles to the polymer particles is from about 1/10, about 2/10, about 3/10, about 4/10, about 5/10 about 6/10, about 7/10, about 8/10, about 9/10, to about 10/9, about 10/8, about 10/7, about 10/6, about 10/5, about 10/4, about 10/3, about 10/2, or about 10/1. In certain embodiments, the weight to weight ratio of the metal oxide particles to the polymer particles is 1/3, 2/3, 1/1, or 3/2.

In further embodiments, the closed-cell metal oxide particles can have, e.g., from about 60.0 wt % to about 99.9 wt % metal oxide, based on the total weight of the closed-cell metal oxide particles. In other embodiments, the closed-cell metal oxide particles comprise from about 0.1 wt % to about 40.0 wt % of one or more light absorbers, based on the total weight of the closed-cell metal oxide particles. In other embodiments, the metal oxide is from any of about 60.0 wt %, about 64.0 wt %, about 67.0 wt %, about 70.0 wt %, about 73.0 wt %, about 76.0 wt %, about 79.0 wt %, about 82.0 wt % or about 85.0 wt % to any of about 88.0 wt %, about 91.0 wt %, about 94.0 wt %, about 97.0 wt %, about 98.0 wt %, about 99.0 wt % or about 99.9 wt % metal oxide, based on the total weight of the closed-cell metal oxide particles.

In certain embodiments, the closed-cell metal oxide particles are prepared by a process comprising forming a liquid dispersion of polymer particles and metal oxide particles; forming liquid droplets of the dispersion; drying the liquid droplets to provide polymer template particles comprising polymer and metal oxide; and removing the polymer to provide closed-cell metal oxide particles. In such embodiments, the resulting closed-cells (and thus the encapsulated voids) are monodisperse.

In certain embodiments, the closed-cell metal oxide particles are prepared by a method comprising: generating liquid droplets from a particle dispersion comprising metal oxide particles and polymer particles; drying the liquid droplets to provide dried particles comprising a matrix of the metal oxide particles embedded with the polymer particles; and calcining or sintering the dried particles to densify the metal oxide particle matrix and remove the polymer particles, resulting in closed-cell metal oxide particles.

In other embodiments, the closed-cell metal oxide particles are prepared by a process comprising: generating liquid droplets from a particle dispersion comprising polymer particles and a sol-gel of a metal oxide; drying the liquid droplets to provide dried particles comprising a matrix of the metal oxide with the polymer particles; and calcining or sintering the dried particles to remove the polymer particles, resulting in closed-cell metal oxide particles. An exemplary process is described as follows: liquid droplets are generated from a particle dispersion (e.g., an aqueous particle dispersion with a pH of 3-5) comprising polymer particles and a precursor of a metal oxide. The precursor may be, for example, tetraethyl orthosilicate (TEOS) or tetramethyl orthosilicate (TMOS) as a silica precursor, titanium propoxide as a titania precursor, or zirconium acetate as a zirconium precursor. The liquid droplets are dried to provide dried particles comprising a hydrolyzed precursor of metal oxide that surrounds and coats the polymer particles. The dried particles are then heated to sinter the metal oxide via a condensation reaction of the hydrolyzed precursor, and to remove the polymer particles via calcination.

In certain embodiments, the evaporation of the liquid medium may be performed in the presence of self-assembly substrates such as conical tubes or silicon wafers. In certain embodiments, dried particle mixtures may be recovered, e.g., by filtration or centrifugation. In certain embodiments, the drying comprises microwave irradiation, oven drying, drying under vacuum, drying in the presence of a desiccant, or a combination thereof.

In certain embodiments, droplet formation and collection occur within a microfluidic device. Microfluidic devices are, for example, narrow channel devices having a micron-scaled droplet junction adapted to produce uniform size droplets, with the channels being connected to a collection reservoir. Microfluidic devices, for example, contain a droplet junction having a channel width of from about 10 μm to about 100 μm. The devices are, for example, made of polydimethylsiloxane (PDMS) and may be fabricated, for example, via soft lithography. An emulsion may be prepared within the device via pumping an aqueous dispersed phase and oil continuous phase at specified rates to the device where mixing occurs to provide emulsion droplets. Alternatively, an oil-in-water emulsion may be utilized. The continuous oil phase comprises, for example, an organic solvent, a silicone oil, or a fluorinated oil. As used herein, “oil” refers to an organic phase (e.g., an organic solvent) immiscible with water. Organic solvents include hydrocarbons, for example, heptane, hexane, toluene, xylene, and the like.

In certain embodiments with liquid droplets, the droplets are formed with a microfluidic device. The microfluidic device can contain a droplet junction having a channel width, for example, of from any of about 10 μm, about 15 μm, about 20 μm, about 25 μm, about 30 μm, about 35 μm, about 40 μm, or about 45 μm to any of about 50 μm, about 55 μm, about 60 μm, about 65 μm, about 70 μm, about 75 μm, about 80 μm, about 85 μm, about 90 μm, about 95 μm, or about 100 μm.

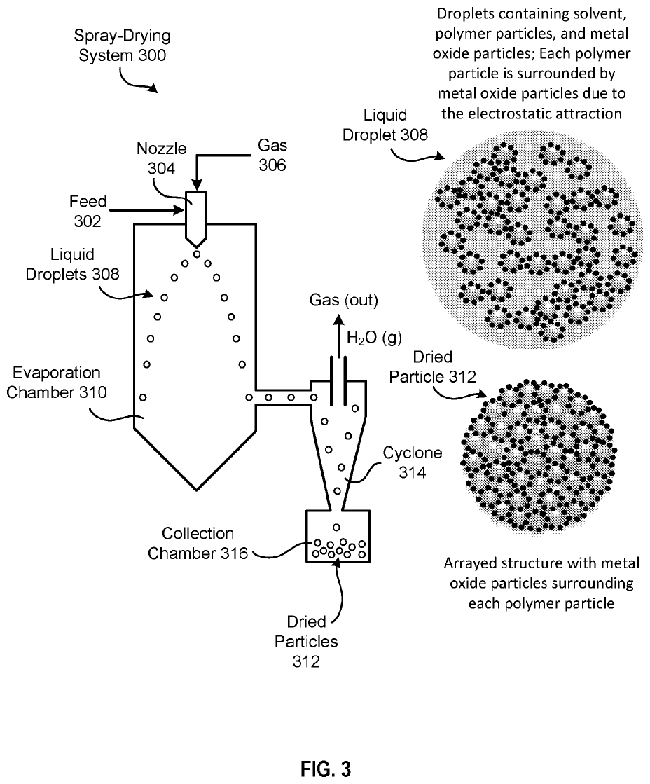

In certain embodiments, generating and drying the liquid droplets is performed using a spray-drying process. FIG. 3 shows a schematic of an exemplary spray drying system 300 used in accordance with various embodiments of the present disclosure. In certain embodiments of spray-drying techniques, a feed 302 of a liquid solution or dispersion is fed (e.g. pumped) to an atomizing nozzle 304 associated with a compressed gas inlet through which a gas 306 is injected. The feed 302 is pumped through the atomizing nozzle 304 to form liquid droplets 308. The liquid droplets 308 are surrounded by a pre-heated gas in an evaporation chamber 310, resulting in evaporation of solvent to produce dried particles 312. The dried particles 312 are carried by the drying gas through a cyclone 314 and deposited in a collection chamber 316. Gases include nitrogen and/or air. In an embodiment of an exemplary spray-drying process, a liquid feed contains a water or oil phase, the metal oxide, and the polymer particles. The dried particles 312 comprise a self-assembled structure of each polymer particle surrounded by metal oxide particles.

Air may be considered a continuous phase with a dispersed liquid phase (a liquid-in-gas emulsion). In certain embodiments, spray-drying comprises an inlet temperature of from any of about 100° C., about 105° C., about 110° C., about 115° C., about 120° C., about 130° C., about 140° C., about 150° C., about 160° C., or about 170° C. to any of about 180° C., about 190° C., about 200° C., about 210° C., about 215° C., or about 220° C. In certain embodiments a pump rate (feed flow rate) of from any of about 1 mL/min, about 2 mL/min, about 5 mL/min, about 6 mL/min, about 8 mL/min, about 10 mL/min, about 12 mL/min, about 14 mL/min, or about 16 mL/min to any of about 18 mL/min, about 20 mL/min, about 22 mL/min, about 24 mL/min, about 26 mL/min, about 28 mL/min, or about 30 mL/min is utilized.

In certain embodiments, vibrating nozzle techniques may be employed. In such techniques, a liquid dispersion is prepared, and then droplets are formed and dropped into a bath of a continuous phase. The droplets are then dried. Vibrating nozzle equipment is available from BUCHI and comprises, for example, a syringe pump and a pulsation unit. Vibrating nozzle equipment may also comprise a pressure regulation valve.

In certain embodiments, polymer removal may be performed, for example, via calcination, pyrolysis, or with a solvent (solvent removal). Calcination is performed in certain embodiments at temperatures of at least about 200° C., at least about 500° C., at least about 1000° C., from about 200° C. to about 1200° C., or from about 200° C. to about 700° C. The calcining can be for a suitable period, e.g., from about 0.1 hour to about 12 hours or from about 1 hour to about 8.0 hours. In other embodiments, the calcining can be for at least about 0.1 hour, at least about 1 hour, at least about 5 hours, or at least about 10 hours. In other embodiments, the calcining can be from any of about 200° C., about 350° C., about 400° C., 450° C., about 500° C. or about 550° C. to any of about 600° C., about 650° C., about 700° C., or about 1200° C. for a period of from any of about 0.1 h (hour), about 1 h, about 1.5 h, about 2.0 h, about 2.5 h, about 3.0 h, about 3.5 h, or about 4.0 h to any of about 4.5 h, about 5.0 h, about 5.5 h, about 6.0 h, about 6.5 h, about 7.0 h, about 7.5 h about 8.0 h, or about 12 h. While the polymer is removed during this process, an array of void volumes will be substantially maintained by the closed-cells left behind after the calcination.

In certain embodiments, a particle size ratio of the metal oxide particles to the polymer particles is from 1/50 to 1/5 (e.g., 1/10).

In certain embodiments, the metal oxide particles have an average diameter of from about 1 nm, about 5 nm, about 10 nm, about 15 nm, about 20 nm, about 25 nm, about 30 nm, about 35 nm, about 40 nm, about 45 nm, about 50 nm, about 55 nm, or about 60 nm to about 65 nm, about 70 nm, about 75 nm, about 80 nm, about 85 nm, about 90 nm, about 95 nm, about 100 nm, about 105 nm, about 110 nm, about 115 nm, or about 120 nm. In other embodiments, the matrix nanoparticles have an average diameter of about 5 nm to about 150 nm, about 50 to about 150 nm, or about 100 to about 150 nm.

In certain embodiments, the polymer particles have an average diameter of from about 50 nm to about 990 nm. In other embodiments, the particles have an average diameter of from any of about 50 nm, about 75 nm, about 100 nm, about 130 nm, about 160 nm, about 190 nm, about 210 nm, about 240 nm, about 270 nm, about 300 nm, about 330 nm, about 360 nm, about 390 nm, about 410 nm, about 440 nm, about 470 nm, about 500 nm, about 530 nm, about 560 nm, about 590 nm, or about 620 nm to any of about 650 nm, about 680 nm, about 710 nm, about 740 nm, about 770 nm, about 800 nm, about 830 nm, about 860 nm, about 890 nm, about 910 nm, about 940 nm, about 970 nm, or about 990 nm.

In certain embodiments, removing the polymer particles comprises calcination, pyrolysis, or solvent removal. The calcining of the polymer particles can be, e.g., at temperatures of from about 300° C. to about 800° C. for a period of from about 1 hour to about 8 hours.

In certain embodiments, the closed-cell metal oxide particles comprise mainly metal oxide, that is, they may consist essentially of or consist of metal oxide. Advantageously, depending on the particle compositions, relative sizes, and shapes of the metal oxide particles used, a bulk sample of the closed-cell metal oxide particles may exhibit color observable by the human eye, may appear white, or may exhibit properties in the UV spectrum. A light absorber may also be present in the particles, which may provide a more saturated observable color. Absorbers include inorganic and organic materials, for example, a broadband absorber such as carbon black. Absorbers may, for example, be added by physically mixing the particles and the absorbers together or by including the absorbers in the droplets to be dried. In certain embodiments, a closed-cell metal oxide particle may exhibit no observable color without added light absorber and exhibit observable color with added light absorber.

The closed-cell metal oxide particles described herein may exhibit angle-dependent color or angle-independent color. “Angle-dependent” color means that observed color has dependence on the angle of incident light on a sample or on the angle between the observer and the sample. “Angle-independent” color means that observed color has substantially no dependence on the angle of incident light on a sample or on the angle between the observer and the sample.

Angle-dependent color may be achieved, for example, with the use of monodisperse polymer particles. Angle-dependent color may also be achieved when a step of drying the liquid droplets is performed slowly, allowing the particles to become ordered. Angle-independent color may be achieved when a step of drying the liquid droplets is performed quickly, not allowing the particles to become ordered.

In certain embodiments, the metal oxide particles can comprise combinations of different types of particles. For example, the metal oxide particles may be a mixture of two different metal oxides (i.e., discrete distributions of metal oxide particles), such as a mixture of alumina particles and silica particles with each species being characterized by the same or similar size distributions.

In certain embodiments, the metal oxide particles may comprise more complex compositions and/or morphologies. For example, the metal oxide particles may comprise particles such that each individual particle comprises two or more metal oxides (e.g., silica-titania particles). Such particles may comprise, for example, a mixture of two or more metal oxides.

In certain embodiments, the metal oxide particles and/or the polymer particles may comprise surface functionalization. An example of a surface functionalization is a silane coupling agent (e.g., silane-functionalized silica). In certain embodiments, the surface functionalization is performed on the metal oxide particles prior to self-assembly and densification. In certain embodiments, the surface functionalization is performed on the closed-cell metal oxide particles after densification. In certain embodiments, the surface-functionalization may be selected to impart a net positive or net negative surface charge to the particles when dispersed in an aqueous solution.

To obtain reflectance over a wide spectral range, more than one type (a blend) of closed-cell metal oxide particles can be incorporated in the coating compositions. A combination of two closed-cell metal oxide particles can increase the spectral range over which reflectance is observed. In certain embodiments, the closed-cell metal oxide particles exhibit an ability to disperse well into the coating compositions and thus uniformly coat a surface. In particular, the closed-cell metal oxide particles are compatible with all types of solvent and coating systems such as acrylics and styrene-acrylic systems.

In certain embodiments, the closed-cell metal oxide particles can include a minor amount of carbon containing material produced in situ from polymer decomposition. In certain embodiments, the closed-cell metal oxide particles can include carbon black or a hydrocarbon material. Carbon black pigments has a high IR absorption and are conventionally used in coatings such as paints and stains. In certain embodiments of the coating compositions disclosed herein, controlled calcination can be employed to produce carbon black in situ in the closed-cell metal oxide particles. The closed-cell metal oxide particles can include materials other than the metal oxides (such as carbon black) in an amount of less than 35% by weight, (e.g., less than 20%, less than 15%, less than 10%, less than 5%, less than 2%, less than 1%, from 0% to 35%, from 0.1% to 20%, from 0.1% to 10%, from 0.1% to 5%, or from 0.1% to 2% by weight), based on the weight of the closed-cell metal oxide particles.

### Waterborne Base Coat

The coating compositions can be formed, e.g., by combining the structural colorants (e.g., closed-cell metal oxide particles as described above) with water, and the at least one water-miscible film-forming binder to form an aqueous topcoat coating composition.

The at least one water-miscible film-forming binder may be dissolved or dispersed in an aqueous medium. Nonlimiting examples of suitable water-miscible film-forming binders may include polyurethane resins, acrylated polyurethane resins, poly(meth)acrylate polymers (acrylic polymers), polyester resins, acrylated polyester resins, polyether resins and alkyd resins. The aqueous topcoat coating composition may also include a binder system including more than one water-miscible film-forming binder.

The at least one water-miscible film-forming binder may be physically dried and/or chemically crosslinked, for example by polymerization, polycondensation, and/or polyaddition reactions. Chemically cross-linkable water-miscible film-forming binders may contain corresponding cross-linkable functional groups. Suitable functional groups may include, for example, hydroxyl groups, carbamate groups, isocyanate groups, acetoacetyl groups, unsaturated groups, for example, (meth)acryloyl groups, epoxide groups, carboxyl groups, and amino groups. The at least one water-miscible film-forming binder may be paired with or include a crosslinking agent. The crosslinking agent may include a complementarily-reactive functional group that may provide crosslinking during curing. For example, hydroxyl group-containing polymers and aminoplast (e.g., melamine) crosslinking agents may be used with chemically crosslinkable water-miscible film-forming binders.

Embodiments including aminoplast crosslinking agents may further include a strong acid catalyst to enhance curing of the aqueous topcoat coating composition. Such catalysts may include, for example, para-toluenesulfonic acid, dinonylnaphthalene disulfonic acid, dodecylbenzenesulfonic acid, phenyl acid phosphate, monobutyl maleate, butyl phosphate, and hydroxy phosphate ester. Strong acid catalysts may also be blocked, e.g., with an amine.

The at least one water-miscible film-forming binder may include ionic and/or nonionic groups such as carboxyl groups and polyethylene oxide segments. Suitable neutralizing agents for the carboxyl groups are basic compounds, such as tertiary amines, for example, triethylamine, dimethylethanolamine, and diethylethanolamine. Alternatively or additionally, the aqueous topcoat coating composition may also include one or more external emulsifiers. The external emulsifier(s) may disperse the water-miscible film-forming binder within the aqueous topcoat coating composition.

In one non-limiting example, the water-miscible film-forming binder is an aqueous polyurethane dispersion. The aqueous polyurethane dispersion may be prepared by emulsifying hydrophobic polyurethanes in water with the aid of one or more external emulsifiers. The aqueous polyurethane dispersion may also be prepared to be self-dispersible by incorporating hydrophilic groups. One technique for imparting water-miscibility or -dispersibility may include converting carboxylate groups into anionic groups using an amine to form an anionic, polyurethane dispersion. Another technique for imparting water-miscibility may include first reacting tertiary amino alcohols with prepolymers which contain free isocyanate functionality, and then neutralizing the reaction product with an acid to form a cationic polyurethane dispersion. A further technique may include modifying prepolymers having free isocyanate functions with water-soluble long-chain polyethers to form a nonionic polyurethane dispersion.

The aqueous topcoat coating composition may alternatively include a hybrid polyurethane-polyacrylate dispersion as the water-miscible film-forming binder. The hybrid polyurethane-polyacrylate dispersion may be prepared by emulsion-polymerizing a vinylpolymer, i.e., a polyacrylate, in an aqueous polyurethane dispersion. Alternatively, the hybrid polyurethane-polyacrylate dispersion may be prepared as a secondary dispersion.

The aqueous topcoat coating composition may include the closed-cell metal oxide particles in an amount of from about 0.01 part by weight to about 60 parts by weight, e.g., from about 1.0 part by weight to about 20 parts by weight, based on 100 parts by weight of the water-miscible film-forming binder. That is, blending may include adding to water from about 30 parts by weight of closed-cell metal oxide particles to about 50 parts by weight of closed-cell metal oxide particles based on 100 parts by weight of the at least one water-miscible film-forming binder.

The aqueous topcoat coating composition may further include a rheology control agent and/or film-forming agent such as a colloidal layered silicate. For example, the colloidal layered silicate may provide the aqueous topcoat coating composition with stability and adjust a thixotropic shear-sensitive viscosity of the aqueous topcoat coating composition. The colloidal layered silicate may be synthetically manufactured from an inorganic mineral and may have a colloidal, gel, or sol form. A suitable colloidal layered silicate is commercially available under the trade name Laponite® from the Byk-Chemie GmbH of Wesel, Germany. Therefore, the method may further include blending the colloidal layered silicate, the passivated pigment slurry, water, and the at least one water-miscible film-forming binder to form the aqueous topcoat coating composition.

The aqueous topcoat coating composition may also include other pigments and fillers. Nonlimiting examples of other pigments and fillers may include inorganic pigments such as titanium dioxide, barium sulfate, carbon black, ocher, sienna, umber, hematite, limonite, red iron oxide, transparent red iron oxide, black iron oxide, brown iron oxide, chromium oxide green, strontium chromate, zinc phosphate, silicas such as fumed silica, calcium carbonate, talc, barytes, ferric ammonium, ferrocyanide (Prussian blue), and ultramarine, and organic pigments such as metallized and non-metallized azo reds, quinacridone reds and violets, perylene reds, copper phthalocyanine blues and greens, carbazole violet, monoarylide and diarylide yellows, benzimidazolone yellows, tolyl orange, naphthol orange, nanoparticles based on silicon dioxide, and aluminum oxide or zirconium oxide. The additional pigments can also include one or more flake-like pigments such as aluminum flakes or mica-based flakes.

The pigments may be dispersed in a resin or polymer or may be present in a pigment system which includes a pigment dispersant, such as the water-miscible film-forming binder resins of the kind already described. The pigment and dispersing resin, polymer, or dispersant may be brought into contact under a shear sufficient to break any agglomerated pigment down to primary pigment particles and to wet a surface of the pigment particles with the dispersing resin, polymer, or dispersant. The breaking of the agglomerates and wetting of the primary pigment particles may provide pigment stability and robust color.

The pigments and fillers may be present in the aqueous topcoat coating composition in an amount of less than or equal to about 60 parts by weight based on 100 parts by weight of the aqueous topcoat coating composition. For example, the pigments and fillers may be present in the aqueous topcoat coating composition in an amount of from about 0.5 parts by weight to 50 parts by weight, or from about 1 part by weight to about 30 parts by weight, or from about 2 parts by weight to about 20 parts by weight, or from about 2.5 parts by weight to about 10 parts by weight, based on 100 parts by weight of the aqueous topcoat coating composition. The amount of pigments and fillers present in the aqueous topcoat coating composition may be selected according to a make-up or nature of the pigment, on a depth of desired color of the cured film formed from the aqueous topcoat coating composition, on an intensity of a metallic and/or pearlescent effect of the cured film, and/or on a dispersibility of the pigment.

The aqueous topcoat coating composition may also include additive components such as, but not limited to, surfactants, stabilizers, dispersing agents, adhesion promoters, ultraviolet light absorbers, hindered amine light stabilizers, benzotriazoles or oxalanilides, free-radical scavengers, slip additives, defoamers, reactive diluents, wetting agents such as siloxanes, fluorine compounds, carboxylic monoesters, phosphoric esters, polyacrylic acids and their copolymers, for example polybutyl acrylate and polyurethanes, adhesion promoters such as tricyclodecanedimethanol, flow control agents, film-forming assistants such as cellulose derivatives, and rheology control additives such as inorganic phyllosilicates such as aluminum-magnesium silicates, sodium-magnesium, and sodium-magnesium-fluorine-lithium phyllosilicates of the montmorillonite type. The aqueous topcoat coating composition 14 may include one or a combination of such additives.

The aqueous topcoat coating composition may be suitable for coating automotive components and substrates and may be suitable for original finish and refinish automotive applications. Further, the aqueous topcoat coating composition may be characterized as a monocoat coating composition, and may be structured to be applied to the substrate as a single, uniformly-pigmented layer. Alternatively, the aqueous topcoat coating composition may be characterized as a basecoat/clearcoat coating composition, and may be structured to be applied to the substrate as two distinct layers, i.e., a lower, highly pigmented layer or basecoat, and an upper layer or clearcoat having little or no pigmentation. Basecoat/clearcoat coating compositions may impart a comparatively high level of gloss and depth of color.

### Forming the Aqueous Topcoat Coating System

The method of forming the aqueous topcoat coating system includes combining, reacting, and blending. The method further includes applying a film formed from the aqueous topcoat coating composition to the substrate. Applying may include, for example, spray coating, dip coating, roll coating, curtain coating, knife coating, spreading, pouring, dipping, impregnating, trickling, rolling, and combinations thereof. For automotive applications in which the substrate is, for example, a body panel, applying may include spray coating the aqueous topcoat coating composition onto the substrate. Nonlimiting example of suitable spray coating may include compressed-air spraying, airless spraying, high-speed rotation, electrostatic spray application, hot-air spraying, and combinations thereof. During applying, the substrate may be at rest, and application equipment configured for applying the aqueous topcoat coating composition to the substrate may be moved. Alternatively the substrate, e.g., a coil, may be moved, and the application equipment may be at rest relative to the substrate.

| Nonlimiting examples of suitable substrates include metal substrates such as bare steel, phosphated steel, galvanized steel, or aluminum; and non-metallic substrates, such as plastics and composites. The substrate 44 may also include a layer formed from another coating composition, such as a layer formed from an electrodeposited primer coating composition, primer surfacer composition, and/or basecoat coating composition, whether cured or uncured.

For example, the substrate may be pretreated to include a layer formed from an electrodeposition (electrocoat) primer coating composition. The electrodeposition primer coating composition may be any electrodeposition primer coating composition useful for automotive vehicle coating operations. The electrodeposition primer coating composition may have a dry film thickness of from about 10 μm to about 35 μm and may be curable by baking at a temperature of from about 135° C. to about 190° C. for a duration of from about 15 minutes to about 60 minutes. Nonlimiting examples of electrodeposition primer coating compositions are commercially available under the trade name CathoGuard® from BASF Corporation of Florham Park, New Jersey.

Such electrodeposition primer coating compositions may include an aqueous dispersion or emulsion including a principal film-forming epoxy resin having ionic stabilization, e.g., salted amine groups, in water or a mixture of water and an organic cosolvent. The principal film-forming resin may be emulsified with a crosslinking agent that is reactive with functional groups of the principal film-forming resin under certain conditions, such as when heated, so as to cure a layer formed from the electrodeposition primer coating composition. Suitable examples of crosslinking agents, include, without limitation, blocked polyisocyanates. The electrodeposition primer coating compositions may further include one or more pigments, catalysts, plasticizers, coalescing aids, antifoaming aids, flow control agents, wetting agents, surfactants, ultraviolet light absorbers, hindered amine light stabilizer compounds, antioxidants, and other additives.

The method also includes curing the film to form the aqueous topcoat coating composition. Curing may include, for example, drying the aqueous topcoat coating composition so that at least some of any solvent and/or water is stripped from the film during an evaporation phase. Drying may include heating the film at a temperature of from about room temperature to about 80° C. Subsequently, the film may be baked, for example, under conditions employed for automotive original equipment manufacturer finishing, such as at temperatures from about 30° C. to about 200° C., or from about 70° C. to about 180° C., or from about 90° C. to about 160° C., for a duration of from about 20 minutes to about 10 hours, e.g., about 20 minutes to about 30 minutes for comparatively lower baking temperatures and from about 1 hour to about 10 hours for comparatively higher baking temperatures. In one example, the film may be cured at a temperature of from about 90° C. to about 160° C. for a duration of about 1 hour.

In addition, curing may not occur immediately after applying. Rather, curing may include allowing the film to rest or “flash.” That is, the film may be cured after a certain rest time or “flash” period. The rest time allows the aqueous topcoat coating composition to, for example, level and devolatilize such that any volatile constituents such as solvents may evaporate. Such a rest time may be assisted or shortened by the exposing the film to elevated temperatures or reduced humidity. Curing of the aqueous topcoat coating composition may include heating the film in a forced-air oven or irradiating the film with infrared lamps.

The resulting cured film may have a thickness of from about 5 μm to about 75 μm, e.g., about 30 μm to about 65 μm, depending, for example, upon a desired color or continuity of the cured film. Further, the cured film formed from the aqueous topcoat coating composition 14 may exhibit a metallic and/or pearlescent appearance.

Therefore, the aqueous topcoat coating system may include the substrate and the cured film formed from the aqueous topcoat coating composition and disposed on the substrate. Therefore, the method may also include, after curing, exposing the cured film to light without photo-degrading the cured film. That is, the first layer and the second layer of the passivated pigment slurry may provide the cured film formed from the aqueous topcoat coating composition with excellent photo-degradation protection upon exposure to wavelengths from ultraviolet light, visible light, and/or infrared radiation.

As such, the closed-cell metal oxide particle slurry or dispersion may be used in coating compositions for original finish and refinish automotive coating compositions, such as multicoat coating systems comprising at least one basecoat and at least one clearcoat disposed on the at least, in which the basecoat has been produced using the closed-cell metal oxide particle slurry.

Nonlimiting examples of suitable clearcoat coating compositions may include poly(meth)acrylate polymers, polyvinyl polymers, and polyurethanes. For example, the clearcoat composition may include a carbamate- and/or hydroxyl-functional poly(meth)acrylate polymer. For embodiments including a polymer having hydroxyl and/or carbamate functional groups, the crosslinking agent may be an aminoplast resin.

### Exemplary Coating Compositions

Certain embodiments described herein relate to base coats, ground coats, conventional base clear layering, tricoat layering (i.e., ground coat, mid coat, and clear coat), or other multilayer coating systems. In certain embodiments, the coating compositions may be waterborne, include one or more organic solvents, or a combination thereof. Nonlimiting examples of suitable solvents include aromatic hydrocarbons, ketones, esters, glycol ethers, and esters of glycol ethers. Specific examples include, without limitation, methyl ethyl ketone, methyl isobutyl ketone, n-amyl acetate, ethylene glycol butyl ether and ethylene glycol monobutyl ether acetate, propylene glycol monomethyl ether and propylene glycol monomethyl ether acetate, xylene, ethanol, propanol, isopropanol, n-butanol, isobutanol, tert-butanol, N-methyl pyrrolidone, N-ethyl pyrrolidone, Aromatic 100, Aromatic 150, naphtha, mineral spirits, butyl glycol, and so on.

The coating composition may optionally include further rheology control agents, including high molecular weight mixed cellulose esters, such as CAB-381-0.1, CAB-381-20. CAB-531-1, CAB-551-0.01, and CAB-171-15S (available from Eastman Chemical Company, Kingsport, Tennessee), which may be included in amounts of up to about 5 wt %, or from about 0.1 to about 5 wt %, or from about 1.5 to about 4.5 wt %, based on total binder weight. Further examples include microgel rheology control agents such as crosslinked acrylic polymeric microparticles, which may be included in amounts of up to about 5 wt % of total binder weight; wax rheology control agents such as polyethylene waxes including acrylic acid-modified polyethylene wax (e.g., Honeywell A-C® Performance Additives), poly(ethylene-vinyl acetate) copolymers, and oxidized polyethylenes, which may be included in amounts of up to about 2 wt % on total binder weight; and fumed silicas, which may be included in amounts of up to about 10 wt % on total binder weight or from about 3 to about 12 wt % on total binder weight.

Additional agents, for example hindered amine light stabilizers, ultraviolet light absorbers, anti-oxidants, surfactants, stabilizers, wetting agents, adhesion promoters, etc. may be incorporated into the coating composition. Such additives are well-known and may be included in amounts typically used for coating compositions.

Nonlimiting examples of special effect pigments that may be utilized in basecoat and monocoat topcoat coating compositions include metallic, pearlescent, and color-variable effect flake pigments. Metallic (including pealescent, and color-variable) topcoat colors are produced using one or more special flake pigments. Metallic colors are generally defined as colors having gonioapparent effects. For example, the American Society of Testing Methods (ASTM) document F284 defines metallic as “pertaining to the appearance of a gonioapparent material containing metal flake.” Metallic basecoat colors may be produced using metallic flake pigments like aluminum flake pigments, coated aluminum flake pigments, copper flake pigments, zinc flake pigments, stainless steel flake pigments, and bronze flake pigments and/or using pearlescent flake pigments including treated micas like titanium dioxide-coated mica pigments and iron oxide-coated mica pigments to give the coatings a different appearance (degree of reflectance or color) when viewed at different angles. Metal flakes may be cornflake type, lenticular, or circulation-resistant. Mica-based flakes may be natural or synthetic. Other types of flakes may include, for example, coated aluminum-oxide, coated glass, and coated silicon dioxide. Flake pigments do not agglomerate and are not ground under high shear because high shear would break or bend the flakes or their crystalline morphology, diminishing or destroying the gonioapparent effects. The flake pigments are satisfactorily dispersed in a binder component by stirring under low shear. The flake pigment or pigments may be included in the coating composition in an amount of about 0.01 wt % to about 10 wt %, for example, about 0.01 wt % to about 0.3 wt % or about 0.1 wt % to about 0.2 wt %, about 0.5 wt. % to about 3 wt. %, about 1 wt. % to about 2 wt. %, about 5 wt. % to about 10 wt. %, or about 7 wt. % to about 8 wt. %, in each case based on total binder weight.

Nonlimiting examples of commercial flake pigments include PALIOCROM® pigments, available from Sun Chemical Corp.

Nonlimiting examples of other suitable pigments and fillers that may be utilized in basecoat and monocoat topcoat coating compositions include inorganic pigments such as titanium dioxide, barium sulfate, carbon black, ocher, sienna, umber, hematite, limonite, red iron oxide, transparent red iron oxide, black iron oxide, brown iron oxide, chromium oxide green, strontium chromate, zinc phosphate, silicas such as fumed silica, calcium carbonate, talc, barytes, ferric ammonium ferrocyanide (Prussian blue), and ultramarine, and organic pigments such as metallized and non-metallized azo reds, quinacridone reds and violets, perylene reds, copper phthalocyanine blues and greens, carbazole violet, monoarylide and diarylide yellows, benzimidazolone yellows, tolyl orange, naphthol orange, and so on. The pigment or pigments are preferably dispersed in a resin or polymer or with a pigment dispersant, such as binder resins. In general, the pigment and dispersing resin, polymer, or dispersant are brought into contact under a shear high enough to break the pigment agglomerates down to the primary pigment particles and to wet the surface of the pigment particles with the dispersing resin, polymer, or dispersant. The breaking of the agglomerates and wetting of the primary pigment particles are important for pigment stability and color development. Pigments and fillers may be utilized in amounts typically of up to about 40% by weight, based on total weight of the coating composition.

In certain embodiments, the disclosed basecoats may have about 40 wt % to about 55 wt %, nonvolatile content, and typically may have about 45 wt % to about 50 wt % nonvolatile content, as determined by ASTM Test Method D2369, in which the test sample is heated at 110° C. (230° F.) for 60 minutes.

In certain embodiments, a substrate may be coated by applying a primer layer, optionally curing the primer layer; then applying a basecoat layer and a clearcoat layer, typically wet-on-wet, and curing the applied layers and optionally curing the primer layer along with the basecoat and clearcoat layers if the primer layer is not already cured, or then applying a monocoat topcoat layer and curing the monocoat topcoat layer, again optionally curing the primer layer along with the basecoat and clearcoat layers if the primer layer is not already cured. The cure temperature and time may vary depending upon the particular binder components selected, but typical industrial and automotive thermoset compositions prepared as we have described may be cured at a temperature of from about 105° C. to about 175° C., and the length of cure is usually about 15 minutes to about 60 minutes.

The coating composition can be coated on a substrate by spray coating. Electrostatic spraying is a preferred method. The coating composition can be applied in one or more passes to provide a film thickness after cure of a desired thickness, typically from about 10 to about 40 microns for primer and basecoat layers and from about 20 to about 100 microns for clearcoat and monocoat topcoat layers.

The coating composition can be applied onto many different types of substrates, including metal substrates such as bare steel, phosphated steel, galvanized steel, or aluminum; and non-metallic substrates, such as plastics and composites. The substrate may also be any of these materials having upon it already a layer of another coating, such as a layer of an electrodeposited primer, primer surfacer, and/or basecoat, cured or uncured.

The substrate may be first primed with an electrodeposition (electrocoat) primer. The electrodeposition composition can be any electrodeposition composition used in automotive vehicle coating operations. Non-limiting examples of electrocoat compositions include the CATHOGUARD® electrocoating compositions sold by BASF Corporation, such as CATHOGUARD® 500. Electrodeposition coating baths usually comprise an aqueous dispersion or emulsion including a principal film-forming epoxy resin having ionic stabilization (e.g., salted amine groups) in water or a mixture of water and organic cosolvent. Emulsified with the principal film-forming resin is a crosslinking agent that can react with functional groups on the principal resin under appropriate conditions, such as with the application of heat, and so cure the coating. Suitable examples of crosslinking agents, include, without limitation, blocked polyisocyanates. The electrodeposition coating compositions usually include one or more pigments, catalysts, plasticizers, coalescing aids, antifoaming aids, flow control agents, wetting agents, surfactants, UV absorbers, HALS compounds, antioxidants, and other additives.

The electrodeposition coating composition is preferably applied to a dry film thickness of 10 to 35 micron. After application, the coated vehicle body is removed from the bath and rinsed with deionized water. The coating may be cured under appropriate conditions, for example by baking at from about 275° F. to about 375° F. (about 135° C. to about 190° C.) for between about 15 and about 60 minutes.

Other exemplary coating configurations include:
a waterborne basecoat (conventional) that is applied over a baked primer;
a waterborne basecoat (integrated process) applied over an uncured primer;
a waterborne ground coat and a waterborne midcoat (both conventional) applied over a baked primer;
a waterborne ground coat and waterborne midcoat (both integrated process) applied over an uncured primer;
a solventborne basecoat (conventional) that is applied over a baked primer;
a solventborne basecoat (integrated wet on wet process) applied over uncured primer;
a solventborne ground coat and solventborne midcoat (both conventional) applied over a baked primer; and
a solventborne ground coat and solventborne midcoat (both integrated wet on wet on wet process) applied over an uncured primer.

In the above embodiments, a clearcoat is applied to the uncured color coat. The clearcoat may be solventborne 1 component or solventborne 2 component. After the clearcoat layer is applied, the system is fully cured at a specified bake temperature.

### Alternative Embodiments

In certain embodiments, the closed-cell metal oxide particles utilized in the present invention comprise a metal oxide and an organic material. In certain embodiments, the organic material is present in an amount of from about 0.1% to about 50% w/w of the particles. In certain embodiments, the particles comprise from about 0.5% to about 25% of an organic material; from about 1% to about 10% of an organic material or from about 2% to about 8% of an organic material.

In certain embodiments, the organic material is within the pores of the particles, embedded within the metal oxide matrix, on the outer surface of the particles, or a combination thereof.

In certain embodiments, the organic material is derived from decomposition (e.g., by combustion) of a precursor such as a saccharide.

In certain embodiments, the organic material is carbon black.

In certain embodiments, the closed-cell metal oxide particles utilized in the present invention comprises a metal oxide and a transition metal. In certain embodiments, the molar ratio of transition metal to metal oxide being less than about 2:1.

In certain embodiments, the closed-cell metal oxide particles have a molar ratio of transition metal to metal oxide from about 1:100 to about 1:1; about 1:50 to about 1:2 or about 1:5 to about 1:10.

In certain embodiments, the transition metal is selected from one or more of a Group 3 to 12 transition metal of the periodic table; a Group 4 to 11 transition metal on the periodic table; or a Group 8 to 10 transition metal on the periodic table. In one embodiment, the transition metal is cobalt.

In certain embodiments, the closed-cell metal oxide particles utilized in the present invention comprise metal oxide particles and silane functional groups on at least a portion of the external surface of the closed-cell metal oxide particles.

In certain embodiments the silane functional groups are epoxy silanes, amino silanes, alkyl silanes, alkylhalosilanes or a combination thereof.

In certain embodiments the silyl functional groups are derived from reacting the porous metal oxide microspheres with a silane coupling agent.

In certain embodiments, the silane coupling agent comprises an organo functional group and a hydrolysable functional group bonded directly or indirectly to silicone.

In certain embodiments, the hydrolysable functional group is an alkoxy group.

In certain embodiments, the silyl functional groups are aminoethyl trimethoxy silanes, aminopropyl trimethoxysilanes, glycidoxypropyl trimethoxy silanes or a combination thereof. Certain embodiments can further comprise an acrylic functional resin.

In certain embodiments, the alkylhalosilane is an alkylchlorosilane. In other embodiments, the silane functional groups are decyltrichlorosilanes, perfluorooctyl-trichlorosilanes or a combination thereof.

In other embodiments, the silyl functional groups further prevent or further substantially prevent the infiltration of the liquid medium into void volumes (pores) of the closed-cell metal oxide particles.

In certain embodiments, the reflective spectra of the silane functionalized particles after storage for 24 hours at room temperature, standard atmosphere and relative humidity has a wavelength within 10% of the liquid coating composition prior to storage.

In certain embodiments, the reflective spectra of the silane functionalized particles after storage for 2 days, 5 days, 7 days, 14 days or 28 days at room temperature, standard atmosphere and relative humidity has a wavelength within 8%, 5%, 4% or 2% of the liquid coating composition prior to storage.

Certain embodiments of the closed-cell metal oxide particles exhibit a wavelength range selected from the group consisting of 380 to 450 nm, 451-495 nm, 496-570 nm, 571 to 590 nm, 591, 620 nm and 621 to 750 nm.

In certain embodiments, the closed-cell metal oxide particles can have, e.g., one or more of an average diameter of from about 0.5 μm to about 100 μm, an average porosity of from about 0.10 to about 0.80, and an average void volume diameter of from about 50 nm to about 999 nm. In alternative embodiments, the particles can have, e.g., one or more of an average diameter of from about 1 μm to about 75 μm, an average porosity of from about 0.45 to about 0.65, and an average void volume diameter of from about 50 nm to about 800 nm.

In certain embodiments, the closed-cell metal oxide particles have an average diameter, e.g., of from about 1 μm to about 75 μm, from about 2 μm to about 70 μm, from about 3 μm to about 65 μm, from about 4 μm to about 60 μm, from about 5 μm to about 55 μm or from about 5 μm to about 50 μm; for example, from any of about 5 μm, about 6 μm, about 7 μm, about 8 μm, about 9 μm, about 10 μm, about 11 μm, about 12 μm, about 13 μm, about 14 μm or about 15 μm to any of about 16 μm, about 17 μm, about 18 μm, about 19 μm, about 20 μm, about 21 μm, about 22 μm, about 23 μm, about 24 μm or about 25 μm. Alternative embodiments can have an average diameter of from any of about 4.5 μm, about 4.8 μm, about 5.1 μm, about 5.4 μm, about 5.7 μm, about 6.0 μm, about 6.3 μm, about 6.6 μm, about 6.9 μm, about 7.2 μm or about 7.5 μm to any of about 7.8 μm about 8.1 μm, about 8.4 μm, about 8.7 μm, about 9.0 μm, about 9.3 μm, about 9.6 μm or about 9.9 μm.

In certain embodiments, the closed-cell metal oxide particles have an average porosity, e.g., of from any of about 0.10, about 0.12, about 0.14, about 0.16, about 0.18, about 0.20, about 0.22, about 0.24, about 0.26, about 0.28, about 0.30, about 0.32, about 0.34, about 0.36, about 0.38, about 0.40, about 0.42, about 0.44, about 0.46, about 0.48 about 0.50, about 0.52, about 0.54, about 0.56, about 0.58 or about 0.60 to any of about 0.62, about 0.64, about 0.66, about 0.68, about 0.70, about 0.72, about 0.74, about 0.76, about 0.78, about 0.80 or about 0.90. Other embodiments can have an average porosity of from any of about 0.45, about 0.47, about 0.49, about 0.51, about 0.53, about 0.55 or about 0.57 to any of about 0.59, about 0.61, about 0.63, or about 0.65.

In further embodiments, the structural colorant photonic spheres have an average void volume (pore) diameter, e.g., of from any of about 50 nm, about 60 nm, about 70 nm, 80 nm, about 100 nm, about 120 nm, about 140 nm, about 160 nm, about 180 nm, about 200 nm, about 220 nm, about 240 nm, about 260 nm, about 280 nm, about 300 nm, about 320 nm, about 340 nm, about 360 nm, about 380 nm, about 400 nm, about 420 nm or about 440 nm to any of about 460 nm, about 480 nm, about 500 nm, about 520 nm, about 540 nm, about 560 nm, about 580 nm, about 600 nm, about 620 nm, about 640 nm, about 660 nm, about 680 nm, about 700 nm, about 720 nm, about 740 nm, about 760 nm, about 780 nm, or about 800 nm. Other embodiments can have an average pore diameter of from any of about 220 nm, about 225 nm, about 230 nm, about 235 nm, about 240 nm, about 245 nm or about 250 nm to any of about 255 nm, about 260 nm, about 265 nm, about 270 nm, about 275 nm, about 280 nm, about 285 nm, about 290 nm, about 295 nm, or about 300 nm.

In further embodiments, the closed-cell metal oxide particles can have, e.g., an average diameter of from any of about 4.5 μm, about 4.8 μm, about 5.1 μm, about 5.4 μm, about 5.7 μm, about 6.0 μm, about 6.3 μm, about 6.6 μm, about 6.9 μm, about 7.2 μm or about 7.5 μm to any of about 7.8 μm about 8.1 μm, about 8.4 μm, about 8.7 μm, about 9.0 μm, about 9.3 μm, about 9.6 μm, or about 9.9 μm; an average porosity of from any of about 0.45, about 0.47, about 0.49, about 0.51, about 0.53, about 0.55 or about 0.57 to any of about 0.59, about 0.61, about 0.63, or about 0.65; and an average void volume (pore) diameter of from any of about 220 nm, about 225 nm, about 230 nm, about 235 nm, about 240 nm, about 245 nm or about 250 nm to any of about 255 nm, about 260 nm, about 265 nm, about 270 nm, about 275 nm, about 280 nm, about 285 nm, about 290 nm, about 295 nm, or about 300 nm.

In further embodiments, the structural colorant photonic spheres can have, e.g., from about 60.0 wt % to about 99.9 wt % metal oxide, based on the total weight of the colorants. In other embodiments, the structural colorants comprise from about 0.1 wt % to about 40.0 wt % of one or more light absorbers, based on the total weight of the colorants. In other embodiments, the metal oxide is from any of about 60.0 wt %, about 64.0 wt %, about 67.0 wt %, about 70.0 wt %, about 73.0 wt %, about 76.0 wt %, about 79.0 wt %, about 82.0 wt % or about 85.0 wt % to any of about 88.0 wt %, about 91.0 wt %, about 94.0 wt %, about 97.0 wt %, about 98.0 wt %, about 99.0 wt % or about 99.9 wt % metal oxide, based on the total weight of the structural colorant photonic spheres.

Drying of the polymer/metal oxide particles followed by removal of the polymer provides particles having uniform voids (pores). In general, in the present processes, each droplet provides a single particle. The pore diameters are dependent on the size of the polymer particles. Some compaction may occur upon polymer removal, providing pore sizes somewhat smaller than the original polymer particle size, for example from about 10% to about 40% smaller than the polymer particle size. The pore diameters are uniform as are the polymer particle shape and size. Pore diameters may range in certain embodiments from about 50 nm to about 999 nm. The average porosity of the present metal oxide particles may be relatively high, for example from about 0.10 or about 0.30 to about 0.80 or about 0.90. Average porosity of a particle means the total pore volume, as a fraction of the volume of the entire particle. Average porosity may be called “volume fraction.”

In certain embodiments, the closed-cell metal oxide particles may comprise from about 60.0 wt % (weight percent) to about 99.9 wt % metal oxide and from about 0.1 wt % to about 40.0 wt % of one or more light absorbers, based on the total weight of the particles. In other embodiments, the light absorber can be, e.g., from about 0.1 wt % to about 40.0 wt % of one or more light absorbers, for example comprising from any of about 0.1 wt %, about 0.3 wt %, about 0.5 wt %, about 0.7 wt %, about 0.9 wt %, about 1.0 wt %, about 1.5 wt %, about 2.0 wt %, about 2.5 wt %, about 5.0 wt %, about 7.5 wt %, about 10.0 wt %, about 13.0 wt %, about 17.0 wt %, about 20.0 wt % or about 22.0 wt % to any of about 24.0 wt %, about 27.0 wt %, about 29.0 wt %, about 31.0 wt %, about 33.0 wt %, about 35.0 wt %, about 37.0 wt %, about 39.0 wt % or about 40.0 wt % of one or more light absorbers, based on the total weight of the particles.

The term “bulk sample” means a population of particles. For example, a bulk sample of particles is simply a bulk population of particles, for instance ≥0.1 mg, ≥0.2 mg, ≥0.3 mg, ≥ 0.4 mg, ≥0.5 mg, ≥0.7 mg, ≥1.0 mg, ≥2.5 mg, ≥5.0 mg, ≥10.0 mg or ≥25.0 mg. A bulk sample of particles may be substantially free of other components.

The phrase “exhibits color observable by the human eye” means color will be observed by an average person. This may be for any bulk sample distributed over any surface area, for instance a bulk sample distributed over a surface area of from any of about 1 cm², about 2 cm², about 3 cm², about 4 cm², about 5 cm² or about 6 cm² to any of about 7 cm², about 8 cm², about 9 cm², about 10 cm², about 11 cm², about 12 cm², about 13 cm², about 14 cm² or about 15 cm². It may also mean observable by a CIE 1931 2° standard observer and/or by a CIE 1964 10° standard observer. The background for color observation may be any background, for instance a white background, black background or a dark background anywhere between white and black.

The term “of” may mean “comprising,” for instance “a liquid dispersion of” may be interpreted as “a liquid dispersion comprising.”

The terms “microspheres,” “nanospheres,” “droplets,” etc., referred to herein may mean for example a plurality thereof, a collection thereof, a population thereof, a sample thereof or a bulk sample thereof.

The term “micro” or “micro-scaled” means from about 0.5 μm to about 999 μm. The term “nano” or “nano-scaled” means from about 1 nm to about 999 nm.

The term “monodisperse” in reference to a population of particles means particles having generally uniform shapes and generally uniform diameters. A present monodisperse population of particles for instance may have 90%, 91%, 92%, 93%, 94%, 95%, 96%, 97%, 98% or 99% of the particles by number having diameters within ±7%, ±6%, ±5%, ±4%, ±3%, ±2% or ±1% of the average diameter of the population.

The term “substantially free of” or similar terminology means for example containing ≤5%, ≤4%, ≤3%, ≤2%, ≤1% or ≤0.5% by weight of the component or property that the term modifies.

The articles “a” and “an” herein refer to one or to more than one (e.g. at least one) of the grammatical object. Any ranges cited herein are inclusive. The term “about” used throughout is used to describe and account for small fluctuations. For instance, “about” may mean the numeric value may be modified by ±5%, ±4%, ±3%, ±2%, ±1%, ±0.5%, ±0.4%, ±0.3%, ±0.2%, ±0.1% or ±0.05%. All numeric values are modified by the term “about” whether or not explicitly indicated. Numeric values modified by the term “about” include the specific identified value. For example “about 5.0” includes 5.0.

Unless otherwise indicated, all parts and percentages are by weight. Weight percent (wt %), if not otherwise indicated, is based on an entire composition free of any volatiles, that is, based on dry solids content.

### ILLUSTRATIVE EXAMPLES

The following examples are set forth to assist in understanding the disclosed embodiments and should not be construed as specifically limiting the embodiments described and claimed herein. Such variations of the embodiments, including the substitution of all equivalents now known or later developed, which would be within the purview of those skilled in the art, and changes in formulation or minor changes in experimental design, are to be considered to fall within the scope of the embodiments incorporated herein.

### Paint Formulation

A paint formulation was prepared with the following components:

| Amount (wt %) | Component (Description) |
|---|---|
| 35.562 | Water-based polyurethane |
| 9.015 | OH-functional acrylate resin |
| 17.781 | Daotan ® VTW 6462/36WA 36 wt. % (aliphatic |
| | urethane-acryl-hybrid) |
| 1.280 | Deionized water |
| 10.656 | Cymel ® 327 (methylated, high imino melamine |
| | crosslinker) |
| 4.384 | Branched polyester polymer |
| 9.985 | Ethylene glycol monobutyl ether |
| 0.165 | 20% aqueous solution of dimethylethanolamine |
| 4.460 | Glycol ether TPM |
| 1.115 | 2-ethylhexanol 99.5% min |
| 0.022 | N,N-dimethylethanolamine S |
| 5.575 | Deionized water |

A pigment dispersion formulation was prepared with the following components:

| Amount (wt %) | Component (Description) |
|---|---|
| 30.330 | Acrylic dispersant polymer |
| 41.160 | Deionized water |
| 3.370 | Polyester urethane resin |
| 1.170 | 1-propoxy-2-propanol |
| 4.000 | Pluracol ® 1010 (polyol) |
| 14.000 | Monarch ® 900 (carbon black) |
| 5.390 | Deionized water |
| 0.040 | 20% aqueous solution of dimethylethanolamine |

The acrylic dispersant polymer is formulated as 35.5% solids in a 1:1 solution of water and propylene glycol n-propyl ether. The branched polyester polymer is formulated as 73% solids in 12% propylene glycol n-propyl ether and 15% normal butyl alcohol.

In the following examples, closed-cell metal oxide particles were included in the formulations as a structural colorant, which were produced based on 200 nm polymer template particles and titania matrix particles.

### Example 1

The coating composition was prepared as summarized below, and included an acrylic dispersant and did not include carbon black (none of the pigment dispersion formulation was present). The coating sample was prepared as a drawdown with a clearcoat over a black substrate to a dry film thickness of 10 μm.

Pigment/binder ratio (p/b) = 0.25, 2%
total structural colorant, acrylic dispersion

| | Grams |
|---|---|
| Closed-cell metal oxide particles (CMOP) | 0.50 |
| Acrylic dispersant polymer | 0.15 sonicate with |
| | CMOP + water |
| Deionized water | 4.0 |
| Paint formulation | 10.00 sonicate and |
| | draw down |

The color space values include L*, a*, b*, C*, and h. The L* value is a scale of 0 to 100 that describes how light or how dark the color is. The higher the number the lighter the color is (e.g., a pure bright white would be 100). The a* value defines how the hue appears on the red-green axis; the more negative the number the greener it is. Similarly, the b* scale defines the yellow-blue axis, with a more positive number being more yellow. Color can also be defined using polar coordinates, where the degree of saturation, C*, indicates how vivid the color is. The further away from the origin, the more vivid the color. The hue angle, h, is a representation of the actual hue of the color. Specular reflection (the mirror like reflection) is assigned a value of zero angle. The color is also quantified at 15, 25, 45, 75, and 110 degrees away from the specular reflection. The 15 and 25 degree angles are often referred to as the “flash” angles, the 45 degree angle is often referred to as the “face” angle, and the 75 and 110 degrees are often referred to as the “flop” angles.

The color space values for the coating of Example 1 are summarized as follows:

| Geo. | L* | a* | b* | C* | h |
|---|---|---|---|---|---|
| −15 | 32.47 | −1.49 | −7.46 | 7.61 | 258.71 |
| 15 | 30.74 | −1.53 | −7.75 | 7.9 | 258.84 |
| 25 | 29.66 | −1.64 | −8.23 | 8.39 | 258.72 |
| 45 | 28.9 | −1.71 | −8.69 | 8.85 | 258.87 |
| 75 | 31.01 | −1.8 | −8.62 | 8.81 | 258.21 |
| 110 | 31.5 | −1.9 | −8.47 | 8.68 | 257.35 |

### Example 2

The coating composition was prepared as summarized below, and included an acrylic dispersant and carbon black. The coating sample was prepared as a drawdown with a clearcoat over a black substrate to a dry film thickness of 10 μm.

p/b = 0.25, 2% total structural colorant, 1%
carbon black on structural colorant , acrylic dispersion

| | Grams |
|---|---|
| Closed-cell metal oxide particles (CMOP) | 0.50 |
| Acrylic dispersant polymer | 0.15 sonicate with |
| | CMOP + water |
| Deionized water | 4.0 |
| Paint formulation | 10.00 |
| Pigment dispersion formulation | 0.04 sonicate and |
| | draw down |

The color space values for the coating of Example 2 are summarized as follows:

| Geo. | L* | a* | b* | C* | h |
|---|---|---|---|---|---|
| −15 | 25.42 | −0.81 | −2.93 | 3.04 | 254.55 |
| 15 | 23.28 | −0.94 | −3.35 | 3.47 | 254.38 |
| 25 | 21.7 | −1.13 | −4 | 4.16 | 254.27 |
| 45 | 20.92 | −1.29 | −4.55 | 4.73 | 254.11 |
| 75 | 22.93 | −1.36 | −4.54 | 4.74 | 253.32 |
| 110 | 22.92 | −1.39 | −4.41 | 4.62 | 252.47 |

### Example 3

The coating composition was prepared as summarized below, and included an acrylic dispersant and carbon black. The coating sample was prepared as a drawdown with a clearcoat over a black substrate to a dry film thickness of 10 μm.

p/b = 0.25, 2% total PB, 1% CB on PB, polyester dispersion

| | Grams |
|---|---|
| Closed-cell metal oxide particles (HMOP) | 0.50 |
| Branched polyester polymer | 0.17 sonicate with |
| | CMOP + water |
| Deionized water | 4.0 |
| Paint formulation | 10.00 |
| Pigment dispersion formulation | 0.04 sonicate and |
| | draw down |

The color space values for the coating of Example 2 are summarized as follows:

| Geo. | L* | a* | b* | C* | h |
|---|---|---|---|---|---|
| −15 | 18.79 | −0.34 | −3.19 | 3.2 | 263.84 |
| 15 | 17.52 | −0.48 | −3.25 | 3.29 | 261.63 |
| 25 | 16.3 | −0.73 | −4.04 | 4.1 | 259.79 |
| 45 | 15.44 | −0.91 | −4.57 | 4.66 | 258.75 |
| 75 | 17.03 | −1.02 | −4.51 | 4.62 | 257.26 |
| 110 | 16.88 | −1.09 | −4.58 | 4.7 | 256.64 |

In the foregoing description, numerous specific details are set forth, such as specific materials, dimensions, processes parameters, etc., to provide a thorough understanding of the embodiments of the present disclosure. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The closed cell microspheres provide a color position that shows minimal angle-dependency on hue. This relatively angle-independent behavior allows formulators to generate colors with a slight red-bluish cast. Modifications to the coating formulation to enhance or change the degree of dispersion of the closed cell microspheres can push the color hue and saturation into a different area.

The term “comprising,” or variations thereof, as used herein is used synonymously with the term “including,” or variations thereof, and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

The particular features, structures, materials, or characteristics may be combined in any suitable manner in one or more embodiments. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion.

As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Reference throughout this specification to “an embodiment,” “certain embodiments,” or “one embodiment” means that a particular feature, structure, or characteristic described in connection with the embodiment is included in at least one embodiment. Thus, the appearances of the phrase “an embodiment,” “certain embodiments,” or “one embodiment” in various places throughout this specification are not necessarily all referring to the same embodiment, and such references mean “at least one.”

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

1. A coating composition comprising: (i) a solvent; (ii) a resinous binder; and (iii) a structural colorant comprising closed-cell metal oxide particles.

2. The coating composition of claim 1, wherein each closed-cell metal oxide particle comprises a metal oxide matrix defining an array of closed-cells, wherein each closed-cell encapsulates a media-inaccessible void volume, wherein the outer surface of the closed-cell metal oxide particle is defined by the array of closed-cells.

3. The coating composition of claim 2, wherein the metal oxide matrix comprises a metal oxide selected from silica, titania, alumina, zirconia, ceria, iron oxides, zinc oxide, indium oxide, tin oxide, chromium oxide, and combinations thereof.

4. The coating composition of claim 2, wherein the array of the closed-cells is an ordered array or a disordered array.

5. The coating composition of claim 1, wherein the closed-cell metal oxide particles have one or more of: (1) an average diameter of from about 1 μm to about 75 μm, (2) an average void volume diameter of from about 50 nm to about 800 nm, or (3) an average porosity of from about 0.45 to about 0.65.

6. The coating composition of claim 1, wherein the structural colorant exhibits angle-dependent color or angle-independent color.

7. The coating composition of claim 1, wherein the ratio of structural colorant to resinous binder is about 1:100 to about 50:100; about 5:100 to about 25:100; about 10:100 to about 20:100; or about 15:100.

8. The coating composition of claim 1, wherein the structural colorant is de-agglomerated preferably by sonification.

9. The coating composition of claim 1, wherein at least a portion of the external surface of the structural colorant comprises silane functional groups.

10. The coating composition of claim 1, wherein the structural colorant comprises transition metal ions or carbon black.

11. The coating composition of claim 1, formulated as an automotive coating.

12. A coating derived from the coating composition of claim 1.

13. The coating of claim 12, further comprising:
a clear coat layer, wherein the clear coat is layered over a colorant layer comprising the structural colorant; and
one or more additional layers (i) between a ground layer and the colorant layer, (ii) between the colorant layer and the clear coat layer, (iii) over the clear coat layer, (iv) under the ground layer, or a combination thereof.

14. An article of manufacture comprising a substrate and the coating of claim 12, wherein the substrate is an automotive part.

15. A method of preparing a coating composition comprising mixing a solvent, a resinous binder and a structural colorant comprising photonic spheres to obtain the coating composition of claim 1.
